(19) United States
(12) Patent Application Publication
(10) Pub. No.: US 2015/0230389 A1
(43) Pub. Date: Aug. 20, 2015

(54) Soil Cultivation Device Having a Device for Stacking, Collecting or Cultivating Soil or Mulch

(71) Applicant: LEMKEN GmbH & Co. KG, Alpen (DE)

(72) Inventors: Georg Paulessen, Willich (DE); Georg Achten, Tonisvorst (DE); Sebastian Karsten, Xanten-Luttingen (DE); Ludger Maas, Sonsbeck (DE); Christoph Happe, Alpen (DE)

(21) Appl. No.: 14/420,906

(22) PCT Filed: Aug. 1, 2013
(86) PCT No.: PCT/DE2013/000425

§ 371 Date: Feb. 11, 2015

(30) Foreign Application Priority Data
Aug. 11, 2012 (DE) 10 2012 016 348.7

(51) Int. Cl. A01B 63/24; A01B 63/26; A01B 73/02

(52) U.S. Cl. CPC A01B 63/24; A01B 73/02; A01B 63/26

(57) ABSTRACT

The invention refers to centrally adjustable actuators for devices for piling up, collecting or handling earth or mulch, which, depending on the weight of the device, can be used geared up, reduced or linearly. The actuators each have toothed segments with several teeth, which are connected with chain link type pinions fixed in the direction of adjustment but yielding and pivoted. The chain link type pinions are designed to pivot, slide or swivel in such a way that on a turn of the chain link type pinion by 180° the toothed segment and this the devices are changed in their working position displaced by a tooth distance and the chain link type pinions are moved backwards and forwards during this by a half tooth distance.

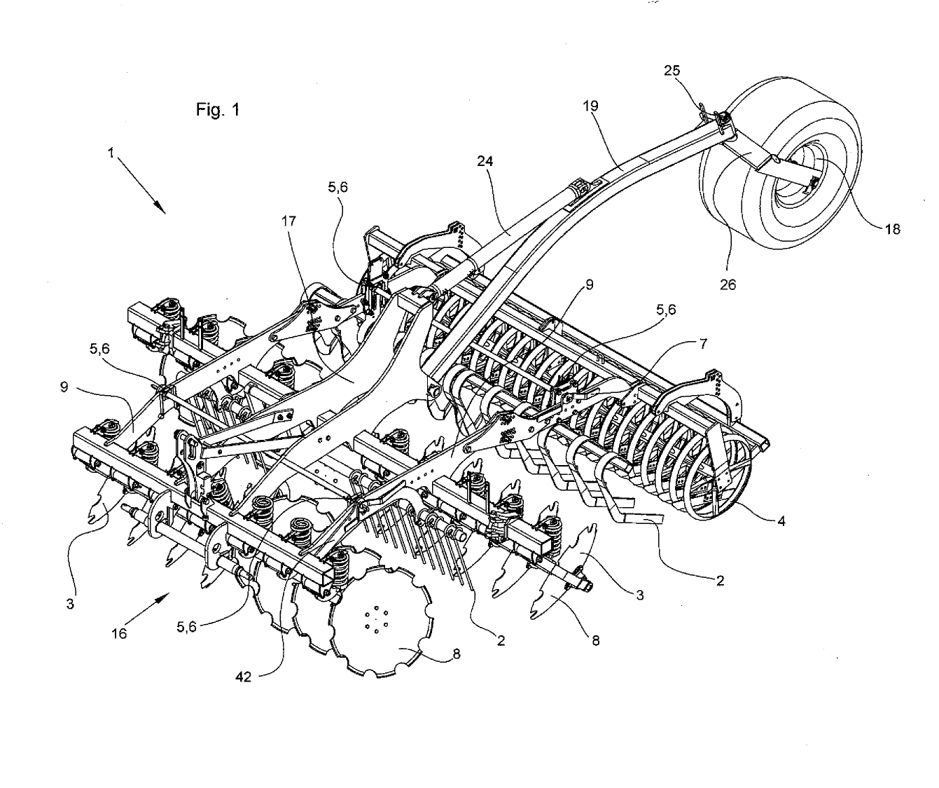

FIG. 1 is to be provided for publication.

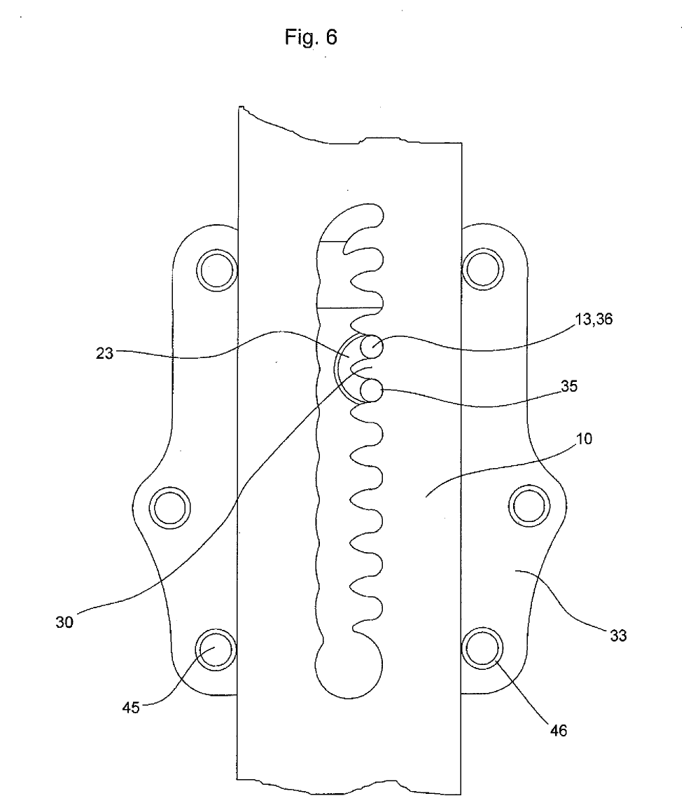

The invention refers to a soil tillage implement in accordance with the characterising clause of patent claim 1. This type of soil tillage implement can be seen, for example, in the German utility patent G 8119215, in which FIG. 6 shows a centrally adjustable device with two actuators and with two right-angle gears that are connected to each other via a cross shaft. The spindles of the two actuators are adjusted by means of a hand wheel in such a way that the device is brought into the desired working position.

This design is very complicated and it is not maintenance-free. The chosen working position can change during use if additional means of securing are not provided. Setting by means of spindles is, on the one hand, very time-consuming and, on the other, after changes to the working position it is very difficult to return to a previously selected working position. This can only be guaranteed by counting the spindle revolutions. At least theoretically, the left and right working position cannot be set the same left and right, because, in dependence on the friction in the device guides, the torsion in the cross shaft cannot guarantee this. The German utility patent DE 20 2007 016 639 U1 shows a riding surface maintenance machine in which two plough halves are fixed movably along a guide rail with positioning means.

A further soil tillage implement can be seen from the applicant's Zirkon rotary harrow brochure with the imprint LEMKEN 02/12 175 0037/de. On page 12, a levelling bar for regulating the flow of earth is shown as a device in which the toothed wheels mesh directly in toothed segments via a cross shaft with toothed wheels and the working position of the devices two positioning devices is changed by turning the cross shaft. For this purpose the cross shaft has a hexagon with which the cross shaft can be turned, e.g. with an open-end or ring spanner. The respective working position is secured by a pin. This version does in fact have a simple structure, but here as well the theoretical case applies in part that torsion of the cross shaft does not make an absolutely identical setting of the device's left and right working position possible. In addition, the set working position has to be secured by means of a pin. If the open-end or ring spanner slips, this causes the device to drop to its lowest working position.

The task of the invention is to create a device that has a simple structure, is largely maintenance-free, is simple to operate and in which a possibly dangerous lowering of the device on operating errors can be prevented safely.

In accordance with the invention the task is solved with the characteristics of claim 1, whereby supplementary and alternative solutions are claimed advantageously in further patent claims.

In that a toothed wheel with two profile gears is formed by the chain link type pinion, when the chain link type pinion is turned the distance between the toothed segment and the axle of the chain link type pinion changes unavoidably. The chain link type pinion, or the bearing of the chain link type pinion, must be arranged practically yieldable. In order to ensure safe functioning of the actuator, means are provided that keep the chain link type pinion engaged. These means ensure that the yielding part, either the chain link type pinion or the bearing, is guided back again, for example by gravity or by an appropriate slanting position of the teeth of the toothed segment. It is also conceivable to design the toothed segment so that it can yield, which makes it no longer necessary for the chain link type pinion or the bearing to yield. Finally, with chain link type pinions a special toothed wheel with two teeth similar to a lantern gear is meant, which can mesh with both teeth at the same time with a gearing, which itself meshes with one of its teeth between the two teeth of the special toothed wheel.

A further embodiment of the invention is one in which the toothed segment is assigned to the soil tillage implement and the bearing to the device.

This embodiment is advantageous if, for example for construction reasons, it is not optimally possible to make the toothed segment into a component of the device and the bearing into a component of the soil tillage implement.

In addition, it is advantageous if the means are designed as energy stores. The provision of energy stores simplifies the embodiment of the actuators, because simple tooth shapes can also be used on the toothed segment, and specially shaped or slanted tooth shapes can be done without.

An advantageous embodiment of the invention is one in which the energy store is designed as a tensional, compression or leaf spring. Simple energy stores such as tensional springs or leaf springs can be integrated into the system without great effort and finally are maintenance-free as well.

Advantageously it is further provided that the actuators are connected to each other by a connecting rod. The provision of a connecting rod can be realised without disadvantages, because the connecting rod is not stressed by torsion in the respective engagement position. If the chain link type pinion is held in the engagement position by a spring, a dead centre position between the teeth of the toothed segment and the chain link type pinion is reached. The device is thus fixed in its working position without additional securing means.

A further advantageous embodiment of the invention is one in which the soil tillage implement is designed to be folding and consists of several assembly units with at least one left assembly unit and at least one right assembly unit, each assembly unit having at least two actuators that are connected to each other for adjusting purposes.

Folding soil tillage implements consist of several assembly units, which considered individually can be centrally adjusted separately.

A preferred embodiment of the invention is one in which the soil tillage implement is designed to be folding and consists of several assembly units with actuators, whereby all actuators in working position are connected to each other in such a way that they are adjustable jointly via a control device in the working position. The actuators of the individual assembly units are connected to each other and can be operated jointly centrally. This embodiment can be used advantageously with lightweight devices. For heavy devices, actuators are to be provided that are supported at least by a motor or by energy stores, if too much force is necessary manually.

Further details of the invention can be seen in the figures and in the description of the figures.

FIG. 1 shows a soil tillage implement with curved concave disks and with devices downstream from the concave disks,

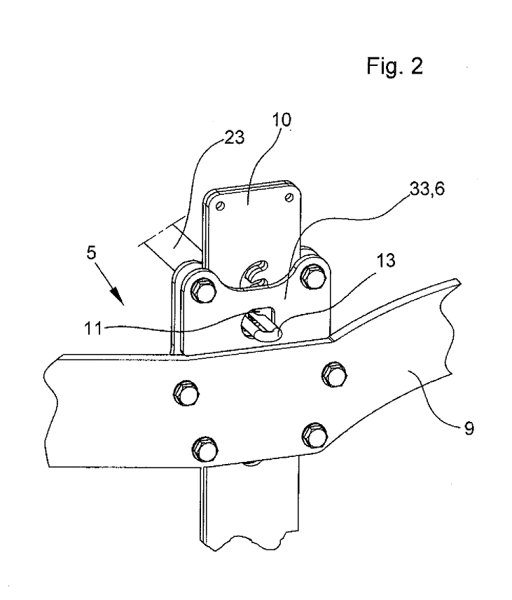

FIG. 2 shows an actuator for the device in the secured state,

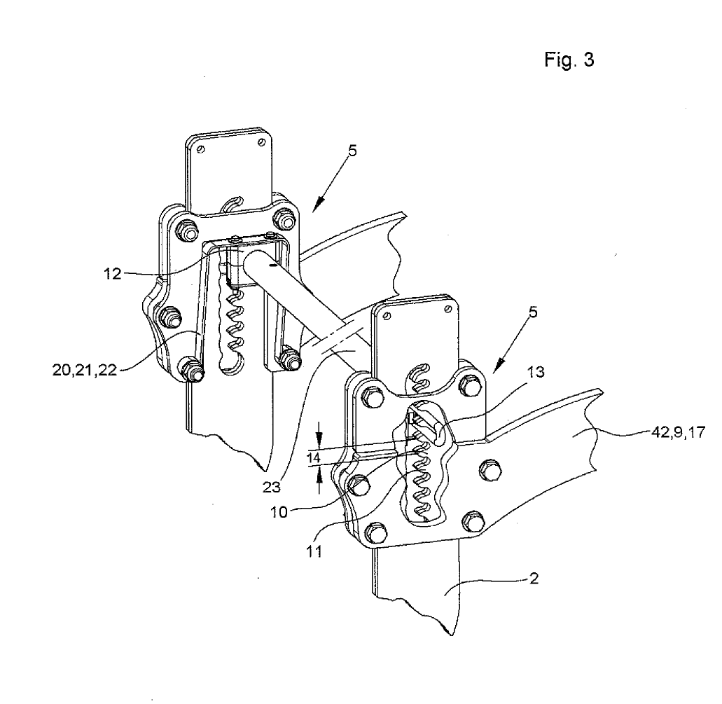

FIG. 3 shows actuators with a partly exposed actuator in the secured state,

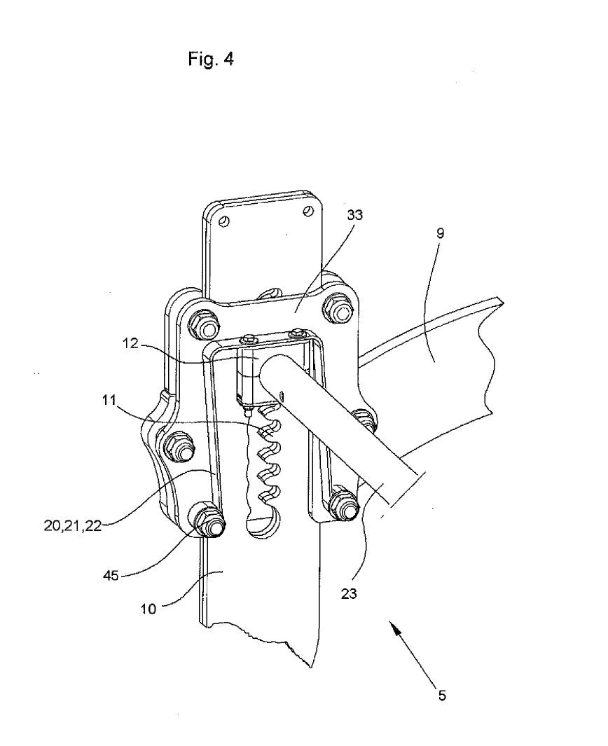

FIG. 4 shows the inside of an actuator,

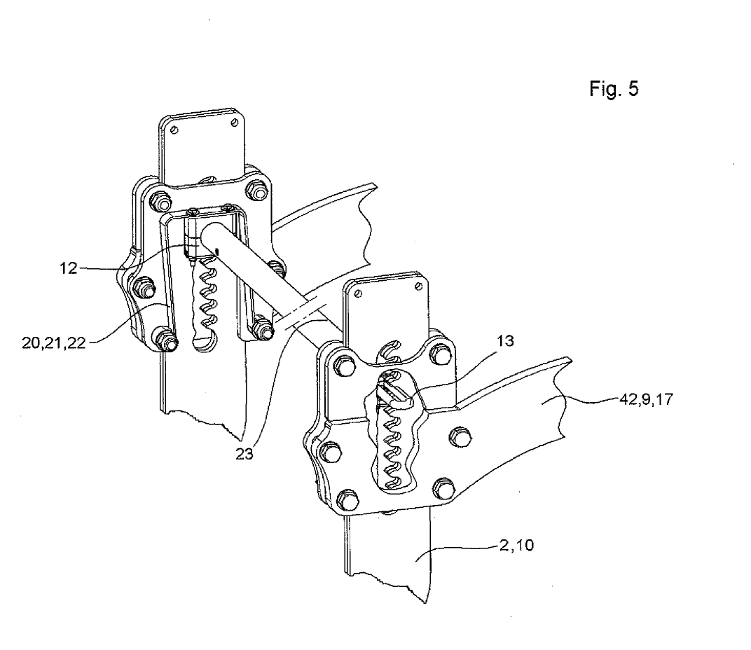

FIG. 5 shows actuators with a partly exposed actuator during a setting process and

FIG. 6 shows a functional sketch of the actuator in the secured state.

FIG. 1 shows a soil tillage implement 1 with tools 3, with devices 2 and with a trailing roller 4. Here, curved disks 8 that are arranged in two rows on the base frame 17 are provided as tools 3. Light ground guide harrows 39 are provided behind the first row 38 as device 2, in contrast, behind the second row 40 heavy ground guide harrows 41 are provided as device 2, which collect the thrown up earth and place it down specifically. The ground guide harrows 39 and 41 are height adjustable and have different weights. The light ground guide harrows 39 can be adjusted with the control part 7 geared via a lever 42 via the actuator 5. The heavy ground guide harrows 41 are adjusted here in a vertical line without gearing via the control part 7 of actuator 5. In front, the soil tillage implement 1 has the headstock 16, with which the soil tillage implement 1 can be attached to the three-point linkage of a tractor. The headstock 16 is connected to the base frame 17, which also holds bearers 9. The bearers 9 are designed here continuously and in multiple parts, they can also be designed as projecting bearers 43, which can be seen, for example, in FIGS. 3, 4 and 5 as well. The bearer arm 19, which carries the support wheel 18 is also found on the base frame 17. The support wheel 18 can be swivelled freely with its wheel fork 26 around the approximately vertical spur axle 25. The support wheel 18 can be lifted for work with the hydraulic cylinder 24. During turning manoeuvres on the headland and for transport, the soil tillage implement 1 is supported by the support wheel 18, which is raised or lowered appropriately via the hydraulic cylinder 24.

FIG. 2 shows an actuator 5 for device 2 in the secured state. The bracket 33, in which the toothed segment 10 is arranged, is fastened to bearer 9. Together with the adjacent components bracket 33 forms a fastening device 6, with which device 2 can be attached to the soil tillage implement 1. Device 2, which is not shown, is arranged on toothed segment 10. The actuator 5 consists here of the linearly and vertically variable toothed segment 10 with teeth 11 and the chain link type pinion 13, which is led in a horizontally yielding bearing 12 and connected to bracket 33, which can be seen in particular in FIG. 4. The chain link type pinion 13 lies with its profile teeth 36 on the roots 35 of the adjacent teeth 11 of the toothed segments, which can be seen in particular in FIG. 6, and in this secured state is meshed automatically through the spring force of the leaf springs 22, which can be seen in FIG. 4.

In FIG. 3 the actuators are shown with a partly exposed actuator in the secured state. This illustrates the meshing of the chain link type pinion 13 in accordance with FIG. 2 in the toothed segment 10. FIG. 3 also illustrates, as does FIG. 5, that two actuators 5 are provided per device 2. The continuous connecting rod 23, which enables central adjustment of both actuators 5, is shown here interrupted for the sake of simplicity. Bearer 9 is shown here as a projecting bearer 43 that is indirectly connected to the base frame 17 or can also be part of base frame 17.

FIG. 4 shows the inner side of an actuator 5 with bearing 12 and leaf springs 22. In bearing 22 the connecting rod 23 can be moved horizontally, but is fixed vertically, and thus the chain link type pinion as well, which is arranged at the end on connecting rod 23. The bearing 22 with the connecting rod 23 and the chain link type pinion 13 is pressed in the direction of the teeth 11 of the toothed segment 10 by the pretensioned leaf spring 22. The chain link type pinion 13 meshes in this way with its profile teeth 36 in the teeth 11 of the toothed segment 10, as is illustrated in FIGS. 2 and 3. It is then in the secured state and has, as it were, a self-retaining effect. Separate securing means are not required, because the chain link type pinion 13 is in the dead centre position, which can be seen in particular in FIG. 6.

FIG. 5 shows a partly exposed actuator 5 during a positioning procedure. The chain link type pinion 13 is found here in a position turned by 90° in relation to the secured state in accordance with FIG. 2. In this, the chain link type pinion 13 along with bearing 12 is slid by about the half distance of the tooth distance 14 of teeth 11 horizontally against the spring force of the leaf spring 22. If the control 7, which is not shown here, slips, the toothed segment 10 could only be adjusted by a maximum of one tooth distance 14 of teeth 11 and then be in a secured state again.

FIG. 6 shows a functional sketch of actuator 5 in the secured state. It also illustrates how the toothed segment 10 in bracket 33 is guided linearly by means of screws 45 and bushings 46. The distance of the two profile teeth 36 to each other corresponds roughly to the tooth distance 14 of teeth 11 to each other in toothed segment 10. The imaginary centre axis 30 of the chain link type pinion is located in the area of the teeth 11 of toothed segment 10. The profile teeth 36 of the chain link type pinion 13 lie on the tooth roots 35 and are held in this position by leaf spring 22, which is not shown. If the rod 23, and thus the chain link type pinion 13, is turned by 90°, the imaginary centre axis 30 of the chain link type pinion is displaced by half of the distance of the two profile teeth 36 from each other. The bearing 12 with connecting rod 23 must yield horizontally to this extent as well.

1. Soil tillage implement (1) with a device (2) for piling up, collecting or handling earth or mulch that is thrown up or worked by the tools (3) of the soil tillage implement (1) or by a trailing roller (4), whereby the device (2) has at least two actuators (5) connected to each other, which can be adjusted centrally by controls (7),
characterised in that
the respective actuator (5) has a toothed segment (10) with several teeth (11), into which a chain link type pinion (13) with two profile teeth (36) pivoted in a bearing (12) meshes, whereby the bearing (12) can be slid or swivelled in such a way that with a turn of the chain link type pinion (13) by 180° the toothed segment (10) is displaced by a tooth distance (14) and the bearing (12) is moved to and for by about a half tooth distance (15) and that means (20) are provided that lead the chain link type pinion (13) or the bearing (12) back in the direction of the toothed segment (10), whereby the toothed segment (10) is a component of device (2) and the bearing (12) is a component of the soil tillage implement (1).

2. Soil tillage implement in accordance with claim 1,
characterised in that
that the toothed segment (10) is assigned to the tillage implement (1) and the bearing (12) to the device (2).

3. Soil tillage implement in accordance with claim 1,
characterised in that
that the means (20) are designed as an energy store (21).

4. Soil tillage implement in accordance with claim 3,
characterised in that
that the energy store (21) is designed as a tension, compression or leaf spring (22).

5. Soil tillage implement in accordance with claim 1,
characterised in that
that the actuators 5 are connected to each other by a connecting rod (23).

6. Soil tillage implement in accordance with claim 1,
characterised in that
that the soil tillage implement (1) is designed to be foldable and consists of several assembly units with at least one left assembly unit and at least one right assembly unit, whereby each assembly unit has at least two actuators (5) that are linked to each other for adjusting purposes.

7. Soil tillage implement in accordance with claim 1,
characterised in that
that the soil tillage implement (1)) is designed to be foldable and consists of several assembly units with actuators (5), whereby all actuators (5) are linked to each other in the working position in such a way that they can be adjusted jointly via a control in the working position.
